(19) United States
(12) Patent Application Publication
(10) Pub. No.: US 2023/0027896 A1
(43) Pub. Date: Jan. 26, 2023

(54) COMPOSITION FOR ADDITIVE MANUFACTURING

(71) Applicant: Jabil Inc., St. Petersburg, FL (US)

(72) Inventors: Thomas Fry, Victoria, MN (US); Zachary Peterson, New Hope, MN (US); Levi Loesch, Minneapolis, MN (US)

(21) Appl. No.: 17/770,781

(22) PCT Filed: Nov. 3, 2020
(86) PCT No.: PCT/US2020/058721

§ 371 Date: Apr. 21, 2022

Related U.S. Application Data
(60) Provisional application No. 62/932,986, filed on Nov. 8, 2019.

(51) Int. Cl. C08L 53/02; B33Y 70/00

(52) U.S. Cl. CPC C08L 53/02; B33Y 70/00; B29C 64/118

(57) ABSTRACT

Compositions useful for making additive manufactured articles are comprised of a styrenic thermoplastic elastomer, the styrenic thermoplastic elastomer being comprised of a block copolymer being comprised of at least two blocks of a vinyl aromatic monomer and at least one block of a conjugated diene monomer, and a solid particulate filler dispersed therein, wherein the filler has a surface area of 0.05 m²/g to 120 m²/g. The compositions may be formed into filaments for use in fused filament fabrication additive manufacturing. The filaments display good printability without drying or storage under dry conditions.

### CROSS REFERENCE TO RELATED APPLICATIONS

The present application is a National Phase Application of PCT/US2020/058721 filed Nov. 3, 2020, which claims the benefit of U.S. Provisional Application 62/932,986 filed on Nov. 8, 2019. The entire contents of these applications are incorporated herein by reference in their entirety.

### FIELD

The present technology relates to thermoplastic compositions useful in additive manufacturing. In particular, the compositions are useful in fused filament fabrication (FFF).

### BACKGROUND OF THE INVENTION

Various additive manufacturing processes, also known as three-dimensional (3D) printing processes, can be used to form three-dimensional objects by fusing or adhering certain materials at particular locations and/or in layers. Material can be joined or solidified under computer control, for example working from a computer-aided design (CAD) model, to create a three-dimensional object, with material, such as liquid molecules, extruded materials including polymers, or powder grains, which can be fused and/or added in various ways including layer-by-layer approaches and print head deposition approaches. Various types of additive manufacturing processes include binder jetting, directed energy deposition, material extrusion, material jetting, powder bed fusion, sheet lamination, vat photopolymerization, and fused filament fabrication.

Fused filament fabrication (FFF) is an additive manufacturing process that employs a continuous filament that may include one or more thermoplastic materials. The filament is dispensed from a coil through a moving, heated extruder printer head, and deposited from the printer head in three dimensions to form the printed object. The printer head moves in two dimensions (e.g., an x-y plane) to deposit one horizontal plane, or layer, of the object being printed at a time. The printer head and/or the object being printed moves in a third dimension (e.g., a z-axis relative to the x-y plane) to begin a subsequent layer that adheres to the previously deposited layer and further described in U.S. Pat. Nos. 5,121,329 and 5,503,785. Because the technique requires melting of a filament and extrusion, the materials have been limited to thermoplastic polymers. Typically, the thermoplastic that has been most successfully printed by the FFF method are aliphatic polyamides (e.g., Nylon 6,6). Thermoplastic elastomers such as thermoplastic polyurethane, acrylonitrile butadiene styrene (ABS) have been reported to have been additive manufactured by FFF, but have not had substantial commercial success due to problems such as water absorption and difficulty to print warp free articles as well as causing sticking to the feed apparatus in the print head and guide tubes of the printer.

Accordingly, it would be desirable to provide a thermoplastic elastomeric composition that avoids one or more of the problems of 3D printing such materials such as those described above.

### SUMMARY OF THE INVENTION

It has been discovered that particular styrenic thermal plastic elastomeric block copolymers (STPEs) containing fillers enables the printing of elastomeric additive manufactured articles without warping, good surface finish, tunable properties (e.g., shore hardness A), without sticking or undesirable moisture absorbance.

A first aspect of the invention is an additive manufacturing composition comprising, a styrenic thermoplastic elastomer, the styrenic thermoplastic elastomer (STPE) being comprised of a block copolymer being comprised of at least two blocks of a vinyl aromatic monomer and at least one block of a conjugated diene monomer. and a solid particulate filler dispersed therein, wherein the filler has a surface area of 0.05 m²/g to 120 m²/g.

A second aspect of the invention is an additive manufactured article comprising at least two layers of the composition of the first aspect of the invention.

A third aspect of the invention is method of printing an object comprising: forming the composition of the first aspect into a filament, drawing, heating and extruding the filament through a print head to form an extrudate, and, depositing the extrudate onto a base such that multiple layers are controllably deposited and fused to form an additive manufactured article.

When practicing the method of the third aspect it has been discovered that the filaments do not need to be dried, stored in a dry atmosphere or stored with a desiccant. Compositions used to form such filaments may vary proportions of the STPE, optional polyolefin, and/or filler to tailor one or more characteristics of the printed article such as the Shore hardness. An amount of filler may be optimized to increase the processability of the STPE by increasing the melt strength of the STPE and inhibit any post-print warping.

Further areas of applicability will become apparent from the description provided herein. The description and specific examples in this summary are intended for purposes of illustration only and are not intended to limit the scope of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Unlike other filaments containing polar groups (e.g., polyamides such as Nylon 6, 6) used in fused filament fabrication, filaments formed from the present compositions have low moisture absorption and can be tailored to provide a desired Shore hardness that is optimized for printing particular objects for particular applications. Filaments according to the present technology can be printed without the need for drying or storage with one or more desiccants.

The Compositions are comprised of a STPE. The STPE is a block copolymer comprised of at least two distinct blocks of a polymerized vinyl aromatic monomer and at least one block of a polymerized conjugated alkene monomer. wherein each block copolymer has at least two blocks of a vinyl aromatic monomer having up to 20 carbon atoms and a conjugated alkene monomer of formula:

R₂C═CR—CR═CR₂

wherein each R, independently each occurrence, is hydrogen or alkyl of one to four carbons, where any two R groups may form a ring. The conjugated diene monomer has at least 4 carbons and no more than about 20 carbons. The conjugated alkene monomer can be any monomer having 2 or more conjugated double bonds. Such monomers include, for example, butadiene, 2-methyl-1,3-butadiene (isoprene), 2-methyl-1,3 pentadiene, and similar compounds, and mixtures thereof. The block copolymer can contain more than one specific polymerized conjugated alkene monomer. In other words, the block copolymer can contain, for example, a polymethylpentadiene block and a polyisoprene block or mixed block(s). In general, block copolymers contain long stretches of two or more monomeric units linked together. Suitable block copolymers typically have an amount of conjugated alkene monomer unit block to vinyl aromatic monomer unit block of from about 30:70 to about 95:5, 40:60 to about 90:10 or 50:50 to 65:35, based on the total weight of the conjugated alkene monomer unit and vinyl aromatic monomer unit blocks.

The vinyl monomer typically is a monomer of the formula:

Ar—C(R¹)—C(R¹)₂

wherein each R¹ is independently in each occurrence hydrogen or alkyl or forms a ring with another R¹, Ar is phenyl, halophenyl, alkylphenyl, alkylhalophenyl, naphthyl, pyridinyl, or anthracenyl, wherein any alkyl group contains 1 to 6 carbon atoms which may optionally be mono or multi-substituted with functional groups. Such as halo, nitro, amino, hydroxy, cyano, carbonyl and carboxyl. Typically, the vinyl aromatic monomer less than or equal 20 carbons and a single vinyl group. In one embodiment, Ar is phenyl or alkyl phenyl, and typically is phenyl. Typical vinyl aromatic monomers include styrene (including conditions whereby syndiotactic polystyrene blocks are produced), alpha-methylstyrene, all isomers of vinyl toluene, especially para-vinyltoluene, all isomers of ethyl styrene, propyl styrene, butyl styrene, vinyl biphenyl, vinyl naphthalene, vinyl anthracene and mixtures thereof. The block copolymer can contain more than one polymerized vinyl aromatic monomer. In other words, the block copolymer may contain a pure polystyrene block and a pure poly-alpha-methylstyrene block or any block may be made up of mixture of such monomers. Desirably, the A block is comprised of styrene and the B block is comprised of butadiene, isoprene or mixture thereof. In an embodiment, the double bonds remaining from the conjugated diene monomer are hydrogenated.

The STPE block copolymers of this invention include triblock, pentablock, multiblock, tapered block, and star block ((AB)ₙ) polymers, designated A(B′A′)ₓB_{y}, where in each and every occurrence A is a vinyl aromatic block or mixed block, B is an unsaturated alkenyl block or mixed block, A, in each occurrence, may be the same as A or of different components or Mw, B′, in each occurrence, may be the same as B or of different components or Mw, n is the number of arms on a Star and ranges from 2 to 10, in one embodiment 3 to 8, and in another embodiment 4 to 6, x is ≥1 and y is 0 or 1. In one embodiment the block polymer is symmetrical such as, for example, a triblock with a vinyl aromatic polymer block of equal Mw, on each end. Typically, the STPE block copolymer will be an A-B-A or A-B-A-B-A type block copolymer. Desirably, the B block is hydrogenated, where a substantial portion (˜50%, 70%, or even 90%) of the double bonds are hydrogenated to essentially all (99% or 99.9%) of the double bonds are hydrogenated.

The block copolymers can have vinyl aromatic monomer unit blocks with individual weight average molecular weighted blocks, M_{w}, of from about 6,000, especially from about 8,000, to sum-total weighted aromatic blocks of about 15,000, to about 45,000. The sum-total, weight average molecular weight of the conjugated alkene monomer unit block(s) can be from about 20,000, especially from about 30,000, more especially from about 40,000 to about 150,000, and especially to about 130,000.

Desirably, the STPE is a styrene-(butadiene)-styrene (SBS), styrene-isoprene-styrene (SIS), styrene isoprene butylene styrene (SIBS), and/or styrene-(ethylene-butylene)-styrene (SEBS). Typically, the styrene blocks provide thermoplastic properties and the butadiene blocks provide the elastomeric properties and may be represented as follows:

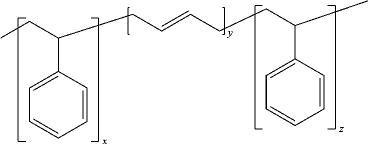

Where x, y, and z are integers to realize the M_{w} for the blocks described above. Selective hydrogenation SBS results in styrene-(ethylene-butylene)-styrene (SEBS), as the elimination of the C═C bonds in the butadiene component generate ethylene and butylene mid-block. SEBS may be characterized by improved heat resistance, mechanical properties and chemical resistance. An example structure of SEBS may be represented by:

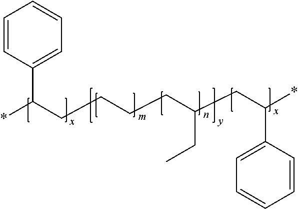

where x, y, z, m and n are any integer to realize the M_{w} of the blocks as described above. Desirably, the STPE is comprised of i styrene-(butadiene)-styrene,styrene-(ethylene-butylene)-styrene or combination thereof. In an embodiment, the STPE is comprised of SEBS wherein essentially all of the unsaturated bonds of the source SBS have been hydrogenated.

Useful STPEs typically have a Shore A hardness value of about 50-90 or 60 to 80 (ASTM D 2240/ISO 868/ISO 7619), a tensile strength—perpendicular of about 3-8, 4-7 or 5-6 MPa (ASTM D412/ISO 37), a tensile strength@100%—perpendicular of about 2 to 6, 3-5.5, or 3.5-4.5 MPa (ASTM D412/ISO 37), an elongation@break—perpendicular of about 200%-700%, 300%-600% or 400%-500% (ASTM D412/ISO 37), a tear strength—perpendicular of about 15 kN/m-60 kN/m, 20 kN/m-50 kN/m, 25 kN/m-45 kN/m or 34 kN/m-42 kN/m (ASTM D624/ISO 34), and a specific gravity (relative density) of about 0.8-1.0 (ASTM D792/ISO 1183). The melt flow rate (MFR) at 210° C. of the STPE may be any useful MFR, but typically is from about 50, 60, 70, 80, 90 g/min to 150, 140, 130, 120, or 110 g/min at 210° C. at 2.16 Kg (ASTM D1238).

In a particular embodiment the STPE has a Shore A hardness value of about 68 to about 72, a tensile strength—perpendicular of about 5.3 to about 5.7 MPa, a tensile strength@100%—perpendicular of about 3.8 to about 4.2 MPa, an elongation@break—perpendicular of about 440 to about 460%, a tear strength—perpendicular of about 36 to about 40 kN/m, an MFR of about 95 g/min to 105 g/min at 230° C., and a specific gravity (relative density) of about 0.90 to about 0.94.

The STPE desirably displays particular rheological behavior at printing conditions such that the STPE has sufficient flow such that it may be printed and fuse or adhere to the previous and subsequent layers when forming an article by FFF. For example, the viscosity of the STPE desirably exhibits shear thinning behavior at the additive manufacturing deposition temperature (extrusion temperature such as about 180° C., 190° C., 200° C. or 210° C. to about 250° C., 240° C., or 230° C.). In particular, the apparent viscosity at low shear (1 s⁻¹) is about 200, 150, 100, 50 or 25 times greater compared to the viscosity at high shear (5000 s⁻¹), wherein the viscosity at the low shear (1 s⁻¹) is from about 1000 to 5000 Pa s. The viscosity may be determined by any suitable rheometer such as those known in the art. For example, a suitable rheometer is an Instron CEAST 20 capillary rheometer (Instron of Norwood, Mass.).

Suitable STPEs may include those commercially available under tradenames such as SEPTON and HYBRAR from Kuraray, (Houston, Tex.). STPEs that may be suitable are also available from Audia Elastomers (Washington, Pa.) under their trade designation TPE. Other suitable STPEs may include those available from Dynasol under the tradename CALPRENE, STPEs from Kraton Corporation (Houston, Tex.) under the KRATON F and G tradenames, Mexpolimeros (Mexico), and Asahi Kasei Corporation (Japan) under tradenames ASAPRENE and TUFPRENE.

It has been discovered that particular fillers are required to realize the desired 3D printability so as to avoid problems such as sticking to the filament feed tubes at the elevated temperatures leading to the print head while retaining desired low moisture absorbance, printed article finish and tolerances (lack of warping for example). The filler has a specific surface area of about 0.05 m²/g to about 120 m²/g, but, desirably, has a specific surface area of 0.1, 0.5, 1, 2 m²/g to about 50, 25, 20, or 10 m²/g. The filler particles may be individual particles or hard agglomerates such as commonly found in fumed silica and carbon blacks. Desirably, the fillers are individual particles. The amount of filler may vary over a large range relative to the STPE and any copolymer blending therewith so long as there is sufficient amount to realize the desired printability. Typically, the amount of filler is from about 1%, 2%, 5%, 10% to 70%, 60%, 50%, 40% or 30% by weight of the composition. The particular amount of filler may also be adjusted to realize one or more desired properties such as stiffness, tensile strength, toughness, heat resistance, color, and clarity of the resulting composition, filament or article formed therefrom.

Generally, the filler may be any shape (e.g., platy, blocky, acicular, whisker spheroidal or combination thereof). Desirably, the filler has an acicular morphology wherein the aspect ratio is at least 2 to 50, wherein the acicularity means herein that the morphology may be needlelike or platy, but preferably is platy. Needlelike meaning that there are two smaller equivalent dimensions (typically referred to as height and width) and one larger dimension (typically the length). Platy meaning that there are two larger somewhat equivalent dimensions (typically width and length) and one smaller dimension (typically height). More preferably, the aspect ratio is at least 3, 4 or 5 to 25, 20 or 15. The average aspect ratio may be determined by micrographic techniques measuring the longest and shortest dimension of a random representative sample of the particles (e.g., 100 to 200 particles).

The particulate size of the filler needs to be a useful size that is not too large (e.g., spans the smallest dimension of filament or causes the filament to become prone to breaking when bent under conditions usually encountered in additive manufacturing) and not too small that the desired effects on the processability and mechanical properties is not realized. In defining a useful size, the particle size and size distribution is given by the median size (D50), D10, D90 and a maximum size limitation. The size is the equivalent spherical diameter by volume as measured by a laser light scattering method (Rayleigh or Mie with Mie scattering being preferred) using dispersions of the solids in liquids at low solids loading. D10 is the size where 10% of the particles have a smaller size, D50 (median) is the size where 50% of the particles have a smaller size and D90 is the size where 90% of the particles have a smaller size by volume. Generally, The filler has an equivalent spherical diameter median (D50) particle size of 0.1 micrometer to 25 micrometers, D10 of 0.05 to 5 micrometers, D90 of 20 to 60 micrometers and essentially no particles greater than about 100 micrometers or even 50 micrometers and no particles smaller than about 0.01 micrometers. Desirably, the median is 0.5 to 5 or 10 micrometers, the D10 is 0.2 to 2 micrometers and the D90 is 5, 10 or 20 to 40 micrometers.

The filler may be any useful filler such as those known in the art. Examples of the filler ceramics, metals, carbon (e.g., graphite, carbon black, graphene), polymeric particulates that do not melt or decompose at the printing temperatures (e.g., cross-linked polymeric particulates, vulcanized rubber particulates and the like), plant based fillers (e.g., wood, nutshell, grain and rice hull flours or particles). Exemplary fillers include calcium carbonate, talc, silica, wollastonite, clay, calcium sulfate, mica, inorganic glass (e.g., silica, alumino-silicate, borosilicate, alkali alumino silicate and the like), oxides (e.g., alumina, zirconia, magnesia, silica “quartz”, and calcia), carbides (e.g., boron carbide and silicon carbide), nitrides (e.g., silicon nitride, aluminum nitride), combinations of oxynitride, oxycarbides, or combination thereof. In certain embodiments, the filler comprises an acicular filler such as talc, clay minerals, chopped inorganic glass, metal, or carbon fibers, mullite, mica, wollastanite or combination thereof. In a particular embodiment, the filler is comprised of talc.

It has also been discovered that polyolefins that are difficult to 3D print without warping and the like may be added to the composition of the present invention in substantial amounts realizing printed parts that do not warp and display desired characteristics of the polyolefin. Examples of polyolefins include polyethylene and polypropylene, as well as polypropylene/polyethylene copolymers. The polyolefin can include various degrees of crystallinity, which can range from 0% (e.g., liquidlike) to 60% or higher (e.g., rigid plastics). Crystallinity can be correlated to the length of the crystallizable sequences of the polymer formed during polymerization thereof. In certain embodiments, the polyolefin comprises polypropylene homopolymers or copolymers of propylene and ethylene such as those referred to impact copolymer polypropylene and ethylene (e.g., produced using Ziegler-Natta catalysts) and random copolymers of propylene and ethylene. Typically, the polyolefin, and, in particular, polypropylene or copolymers of ethylene and propylene have a melt flow rate of about 1 to 50 g/10 minutes (230° C./2.16 kg) ASTM D1238. Desirably, the MFR is from about 0.1, 0.5, 1, 2 or 5 to 20 or 15 g/10 minutes.

When incorporating the polyolefin and, in particular, polypropylene homopolymer or copolymer of propylene and ethylene, to realize desirable mechanical properties and good behavior, it has been surprisingly discovered that the melt flow rate ratio (MFR ratio) of the STPE MFR (210° C./2.16 kg)/polyolefin MFR (230° C./2.16 kg) is desirably at least about 6, 8 or 10 to 200, 100, 50, 20 or 15. That is the melt flow rate of the polyolefin improves printing when it has a substantially lower MFR than the STPE even at a higher temperature.

Suitable polyolefins may include those commercially available from companies such as ExxonMobil, The Dow Chemical Company and LyondellBasell

When the polyolefin is present, the composition may be comprised of about 10-80 wt % of the STPE, about 10-70 wt % of the polyolefin, and about 10-50 wt % of the filler. In other embodiments, the composition may be comprised of 20-70 wt % of the STPE, about 10-60 wt % of the polyolefin, and about 10 wt % to 40 wt % or 30 wt % of the filler. In further embodiments, the composition may be comprised of about 20-50 wt % of the STPE, about 30-60 wt % of the polyolefin, and about 15 wt % to 25 wt % of the filler.

The compositions may be formed into various forms useful in various 3D printing methods such as fused filament fabrication methods. For example, the composition may be formed into pellets, one or more rods, that can be fed into a fused filament fabrication method to print an object. Such pellets, rods, may be fed into an extruder where the composition is further formed into a filament. The filament can be dimensioned in cross-section shape, diameter, and length for use in various fused filament fabrication methods to print various objects using various print heads. The filament can be formed as it is being used in a printing process or the filament can be pre-formed and stored for later use in a printing process. The filament may be wound upon a spool to aid in storage and dispensing. The filament can be formed in various ways, including various extrusion methods using various dies, such as hot extrusion and cold extrusion methods.

In certain embodiments, the fused filament fabrication method can employ material extrusion of the composition to print items, where a feedstock of the composition is pushed through an extruder. The filament can be employed within the three-dimensional printing apparatus or system in the form of a filament wound onto a spool. The three-dimensional printing apparatus or system can include a cold end and a hot end. The cold end can draw the filament from the spool, using a gear- or roller-based feeding device to handle the filament and control the feed rate by means of a stepper motor. The cold end can further advance the filament feedstock into the hot end. The hot end can include a heating chamber and a nozzle, where the heating chamber includes a liquefier, which melts the filament to transform it into a thin liquid. This allows the molten composition to exit from a nozzle to form a thin, tacky bead that can adhere to a surface to which it is deposited upon. The nozzle may have any useful diameter and typically depending on resolution desired has a diameter of between 0.1 or 0.2 mm to 3 mm or 2 mm. Different types of nozzles and heating methods are used depending upon the composition, the object to be printed, and the desired resolution of the printing process.

In certain embodiments, the fused filament fabrication apparatus or system can employ an extruder, where filament is melted and extruded therefrom, in conjunction with a stepper motor and a hot end. The stepper motor can grip the filament, feed the filament to the hot end, which then melts the filament composition and depositing onto the print surface. The fused filament fabrication apparatus or system can employ a direct drive extruder or Bowden extruder. The direct drive extruder can have the stepper motor on the print head itself, where the filament can be pushed directly into the hot end. This configuration has the print head carrying the force of the stepper motor as it moves along the x-axis. The Bowden extruder can have the motor on the frame, away from the print head, and employs a Bowden tube. The motor can feed the filament through the Bowden tube (e.g., a PTFE tube) to the print head. The tube guides the filament from the fixed motor to the moving hot end, protecting the filament from snapping or being stretched by movement of the hot end during the printing process.

Method of printing an object are provided that include using the compositions described herein. For example, a filament formed from the composition can be provided and the object can be printed using the filament in a fused filament fabrication process. Providing the filament can include extruding the composition to from the filament. In certain embodiments, extruding the composition can include using one of a direct drive extruder and a Bowden extruder to form the filament.

Articles may be prepared by a fused filament fabrication process as provided herein. Such articles may be prepared by providing a filament formed from a composition as described and printing the object using the filament in a fused filament fabrication process to form an additive manufactured article comprised of at least two layers of the composition of the present invention. The filament may be formed by extruding the composition through a die with or without heating, but typically with heating. Objects produced by three-dimensional printing using such fused filament fabrication processes can be further processed by machining, milling, polishing, coating, painting, plating, deposition, etc.

### EXAMPLES

The following non-limiting examples demonstrate further aspects of the present technology.

### Examples 1 to 6 and Comparative Example 1

A filament of about 2.85 mm diameter is formed by melt blending at about 210° C. for using twin screw extruder at various loadings of CIMBAR 610D talc with TPE-70IN350, a SEBS STPE from Audia Elastomers that is a triblock A-B-A polymer having a melt flow rate (210° C./2.16 kg): 99 g/10 min (referred to as SEBS in the Examples and Comparative Examples). The SEBS STPE displays shear thinning behavior at 210° C., 220° C. and 230° C. as shown in Table 1. The viscosity is determined using an Instron CEAST 20 capillary rheometer (Instron of Norwood, Mass.) with a die ratio of 20:1. The talc has a platy morphology with a reported D50 of 1 micrometer and D98 of 5.5 micrometer. The talc is loaded from 10 percent to 60 percent in 10% intervals by weight of the STPE and talc (Examples 1 to 6).

Filament is made from the neat SEBS (Comp. Ex. 1) and the talc loaded compositions. 2.85 diameter millimeter filament is made by melt extruding the Example 1 to 6 and Comparative Example compositions in a single screw extruder between about 185° C. to 205° C., which are wound on a spool after passing through a cooling bath. Type IV tensile test specimens having several layers are 3D printed using a Ultimaker S5 fused filament fabrication printer with a printer speed of 15-20 mm/s, layer height of ˜0.15 mm, temperature of 270° C., and build plate temperature of 70° C.

Comparative Example 1 did not print due to sticking to the printer apparatus and breaking during filament formation due to breaking in the cooling bath used to make the filament.

Each of the Example 1 to 6 compositions printed. The higher loaded (40% to 60%) Examples (4-6), display inconsistent filament feed when printed under typical filament fabrication printer conditions. Examples 1-3 having 10% to 30% loading display good print characteristics, the filament displaying sufficient melt strength stiffness to realize printed parts having good appearance, without warping, and adherence of the layers. The mechanical properties of Example 2 (20% by weight of talc) is shown in Table 2.

### Examples 7 to 15

Examples 7 to 13 were made in the same way except that a propylene impact copolymer (LyondellBasell, SEETEC M1400, specific density 0.9 g/cc; MFR 8 g/10 min (230° C./2.16 kg)) of propylene and ethylene made using a Ziegler Natta catalyst is blended with STPE and talc in the weight percentages indicated in Table 3. Detailed mechanical properties of Example 10 are shown in Table 2. Example 7 repeats the formulation of Example 2. Each of these Examples printed well. From Table 3, it is apparent that desired properties may be realized by varying the amount of polypropylene approaching that of the polypropylene as more of it is added, while still achieving good printability. Surprisingly, even at lower loadings of the STPE properties of propylene may be approached, while exhibiting less brittleness and greater impact resistant.

Example 15 is made the same way as Example 10, except that the polypropylene is a high impact propylene-ethylene copolymer (Pro-fax SG702, LyondellBasell, 0.9 g/cc; MFR 18 g/10 min (230° C./2.16 kg)). Example 16 is made the same was as Example 10 except that the polypropylene is a propylene-ethylene copolymer (Chase Plastics Services Inc., PPC100RC-35M, 0.9 g/cc, MFR 35 g/10 min (230° C./2.16 kg)). Examples 15 and 16 print at these conditions, but with breaks and lack of good adhesion between the layers.

The filaments of the compositions of Examples 1 to 15 absorb little moisture compared to other elastomers; e.g., thermoplastic polyurethane (TPU). In particular, filaments formed of TPU generally need to be dried in an oven or stored with desiccants to obtain good three-dimensional print quality using fused filament fabrication. This can be due to a tendency of TPU to absorb moisture from the surrounding air. Filaments containing excessive amounts of water tend to print articles of low quality due to the degradation of the polymer in the hot print head leading to poor mechanical properties and rough surfaces. The filaments of the present invention, do not exhibit a problem with absorbing ambient moisture. In particular, it has been observed that using filaments of the present invention may be stored at room temperature for long periods of time without desiccants without causing any printing problems, whereas TPU (thermoplastic polyurethane), for example, must be dried prior to printing when stored under ambient conditions.

It has also been observed that the addition of polypropylene in the present compositions provides previously unknown benefits. For example, compositions with little or no polyolefin (e.g., polypropylene) tend to be soft, which may lead to bending in the drive of fused filament fabrication 3D printers. Specifically, compositions with little or no polyolefin may be difficult to print on Bowden tube printers, although such compositions may work more effectively on direct drive printers. In Bowden printers, the filament drive is located on the back of the printer and the filament is forced through a long tube up to the print head. In printers where the drive is located far from the print head, there tend to be more friction surfaces for the filament to drag on and bend causing the print process to fail. This problem is reduced or eliminated by further inclusion of include the polyolefin (e.g., polypropylene) as exemplified by Examples 7 to 15.

TABLE 1
Viscosity Measurements at 210, 220 and 230 degrees Celsius

| | Shear | |
|---|---|---|
| Temperature, ° C. | rate (1/s) | Pa * s |
| 210° C. | ~1 | 5,275 |
| 210° C. | 20 | 498 |
| 210° C. | 130 | 93 |
| 210° C. | 572 | 75 |
| 210° C. | 1,102 | 60 |
| 210° C. | 5,157 | 27 |
| 220° C. | 8 | 2,175 |
| 220° C. | 16 | 186 |
| 220° C. | 119 | 62 |
| 220° C. | 542 | 56 |
| 220° C. | 1,052 | 47 |
| 220° C. | 4,985 | 23 |
| 230° C. | ~1 | 2,175 |
| 230° C. | 19 | 186 |
| 230° C. | 121 | 40 |
| 230° C. | 537 | 44 |
| 230° C. | 1,039 | 38 |
| 230° C. | 4,897 | 20 |

TABLE 2

| | | | | Test |
|---|---|---|---|---|
| Property | Example 2 | Example 10 | Units | Standard |
| Elastic Modulus XY | 19.3 | 93 | MPa | ASTM D638 |
| Elastic Modulus Z | 6.8 | 45 | MPa | ASTM D638 |
| Ultimate Tensile | 6.4 | 11 | MPa | ASTM D638 |
| Strength XY | | | | |
| Ultimate Tensile | 3.0 | 4.6 | MPa | ASTM D638 |
| Strength Z | | | | |
| Elongation at Break | 897 | 781 | % | ASTM D638 |
| XY | | | | |
| Elongation at Break | 354 | 50 | % | ASTM D638 |
| Z | | | | |
| Shore Hardness | 82.4 | 96 | Shore A | ASTM 2240 |
| Melt Flow (210 C./ | 61 | 23 | g/10 min | ASTMD1238 |
| 2.16 kg) | | | | |
| Compression Set | 45 | 44 | % | ASTM D395 |
| Tear Strength XY | 66.3 | 97 | N/mm | ASTM D624 |
| Tear Strength Z | 22.7 | 22 | N/mm | ASTMD624 |

TABLE 3

| | SEBS | Polypropylene | Talc | Tensile Strain | Shore A |
|---|---|---|---|---|---|
| Example | (wt %) | (wt %) | (wt %) | at Break (%) | Hardness |
| 7 | 80 | 0 | 20 | 981.09 | 85.6 |
| 8 | 70 | 10 | 20 | 954.73 | 90.8 |
| 9 | 60 | 20 | 20 | 858.89 | 93.6 |
| 10 | 50 | 30 | 20 | 844.85 | 96.0 |
| 11 | 40 | 40 | 20 | 665.09 | 96.8 |
| 12 | 30 | 50 | 20 | 520.07 | 98.4 |
| 13 | 20 | 60 | 20 | 198.96 | 99.8 |

1. An additive manufacturing composition comprising:
a styrenic thermoplastic elastomer, the styrenic thermoplastic elastomer being comprised of a block copolymer being comprised of at least two blocks of a vinyl aromatic monomer and at least one block of a conjugated diene monomer. and a solid particulate filler dispersed therein, wherein the filler has a surface area of 0.05 m²/g to 120 m²/g and is acicular having an aspect ratio of 3 to 25.

2. The composition of claim 1, wherein the conjugated diene monomer is of the formula:
R₂C═CR—CR═CR₂
wherein each R, independently each occurrence, is hydrogen or alkyl of one to four carbons, where any two R groups may form a ring and the vinyl aromatic monomer has at most 20 carbons, and the vinyl aromatic monomer is of the formula:
Ar—C(R¹)—C(R¹)₂
wherein each R¹ is independently in each occurrence hydrogen or alkyl or forms a ring with another R¹, Ar is phenyl, halophenyl, alkylphenyl, alkylhalophenyl, naphthyl, pyridinyl, or anthracenyl, wherein any alkyl group contains 1 to 6 carbon atoms which may optionally be mono or multi-substituted with functional groups.

3. The composition of claim 2, wherein the blocks of the conjugated diene monomer have been hydrogenated to eliminate at least a portion of residual carbon-carbon double bonds.

4. (canceled)

5. The composition of claim 2, wherein the styrenic thermoplastic elastomer is a styrene-(ethylene-butylene)-styrene (SEBS) thermoplastic elastomer.

6. The composition of claim 1, wherein the filler has particle size where the D50 is from about 0.5 micrometer to about 5 micrometer and the D90 is between about 20 to about 40 micrometers and the D10 is about 0.1 micrometer to 2 micrometers.

7. The composition of claim 1, wherein the filler has an aspect ratio of about 5 to about 25.

8. The composition of claim 7, wherein the filler is clay, wollastonite, graphitic carbon, boron nitride, silicon carbide or talc.

9. (canceled)

10. (canceled)

11. (canceled)

12. The composition of claim 1 further comprising a polyolefin.

13. The composition of claim 12, wherein the polyolefin is a homopolymer of propylene, or copolymer of propylene and ethylene.

14. The composition of claim 12, wherein the polyolefin has a melt flow rate of 1 to 50 g/10 minutes at (230° C./2.16 kg).

15. The composition of claim 14, wherein the styrenic thermoplastic elastomer has a melt flow rate of 50 to 150 g/10 minutes at (210° C./2.16 kg).

16. The composition of claim 15, wherein the melt flow rate of the styrenic thermoplastic elastomer at (210° C./2.16 kg) and the melt flow rate of the polyolefin at (230° C./2.16 kg) has a ratio of 10 to 3.

17. (canceled)

18. (canceled)

19. A method of printing an object comprising:
drawing, heating and extruding a filament comprised of a composition comprising a styrenic thermoplastic elastomer, the styrenic thermoplastic elastomer being comprised of a block copolymer being comprised of at least two blocks of a vinyl aromatic monomer and at least one block of a conjugated diene monomer. and a solid particulate filler dispersed therein, wherein the filler has a surface area of 0.05 m²/g to 120 m²/g and is acicular having an aspect ratio of 3 to 25 through a print head to form an extrudate, and, depositing the extrudate onto a base such that multiple layers are controllably deposited and fused to form an additive manufactured article.

20. The method of claim 19 wherein the extruding is by a Bowden extruder having a Bowden tube.

21. (canceled)

22. An article comprising an additive manufactured article comprising a plurality of layers fused or adhered together, wherein at least two layers are comprised of a thermoplastic elastomer comprised of a styrenic thermoplastic elastomer comprised of a block copolymer that is comprised of at least two blocks of a vinyl aromatic monomer and at least one block of a conjugated diene monomer. and a solid particulate filler dispersed therein, wherein the filler has a surface area of 0.05 m²/g to 120 m²/g and is acicular having an aspect ratio of 3 to 25.

23. The article of claim 22, wherein, the styrenic thermoplastic elastomer has been hydrogenated to remove at least a portion of residual double bonds in the conjugated diene monomer block.

24. (canceled)

25. The article of claim 22, wherein the layer is further comprised of a polyolefin that is a homopolymer of polypropylene or copolymer of ethylene and propylene.

26. The article of claim 25, wherein the styrenic thermoplastic elastomer has a melt flow rate at (210° C./2.16 kg) and the polyolefin has a melt flow rate at (230° C./2.16 kg) such that the ratio of said styrenic thermoplastic elastomer to said polyolefin melt flow rate has a ratio of 10 to 3

27. The article of claim 26, wherein the layer is comprised of about 10-80 wt % of the styrenic thermoplastic elastomer; about 10-70 wt % of the polyolefin; and
about 10-30 wt % of the filler.

28. The article of claim 22, wherein the thermoplastic elastomer consists of the styrenic thermoplastic elastomer.
